(19) United States
(12) Patent Application Publication
(10) Pub. No.: US 2008/0283344 A1
(43) Pub. Date: Nov. 20, 2008

(54) VEHICLE BRAKING SYSTEM

(75) Inventors: Ryuta Inoue, Shizuoka-ken (JP); Seiji Nakagaki, Shizuoka-ken (JP); Takeshi Ito, Shizuoka-ken (JP)

Correspondence Address: KNOBBE MARTENS OLSON & BEAR LLP, 2040 MAIN STREET, FOURTEENTH FLOOR, IRVINE, CA, 92614, US

(73) Assignee: YAMAHA HATSUDOKI KABUSHIKI KAISHA, Shizuoka-ken (JP)

(21) Appl. No.: 12/118,042

(22) Filed: May 9, 2008

(30) Foreign Application Priority Data
May 10, 2007 (JP) 2007125516

(51) Int. Cl. F16D 55/36

(52) U.S. Cl. 188/71.5

(57) ABSTRACT

A vehicle braking system that eases assembly of a plurality of rotational friction plates and a plurality of fixed friction plates to a system body. The braking system can include a plurality of rotational friction plates and a plurality of fixed friction plates assembled on a periphery of an annular member such that each of the fixed friction plates is positioned between a pair of the rotational friction plates. A retaining member, such as a circlip, is engaged with each end of the annular member for preventing the rotational friction plates and the fixed friction plates from becoming disengaged with the annular member by axial movement. In addition, outer fixed friction plates can be positioned on each end of the collection of rotational friction plates and fixed friction plates. Pins can be extended through the outer fixed friction plates and retaining members, such as circlips are provided on respective ends of the pins to permit limited relative movement of the outer friction plates relative to one another in the axial direction.

### RELATED APPLICATIONS

This application is related to, and claims the benefit of, Japanese Patent Application No. 2007-125516, filed May 10, 2007, the entirety of which is hereby incorporated by reference herein and made a part of the present specification.

### BACKGROUND OF THE INVENTION

1. Field of the Invention

The present invention relates to a vehicle braking system for slowing a vehicle or bringing a vehicle to a stop by pressing a plurality of rotational friction plates and a plurality of fixed friction plates against one another.

2. Description of the Related Art

Conventionally, a vehicle is provided with a braking system, and a moving vehicle can be slowed or brought to a stop by operation of the braking system. One such braking system includes a plurality of brake plates that can be selectively pressed against one another to slow or stop a vehicle. One example of a multi-plate braking system is illustrated in U.S. Pat. No. 5,466,052. In this braking system, a plurality of first brake plates are spline-fitted to an interior of a housing, and each of a plurality of second brake plates is disposed between a pair of the first brake plates. The inner peripheries of the second brake plates are spline-fitted to the periphery of a cylindrical brake hub, and an axle is spline-fitted to a spline formed on an inner periphery of the brake hub.

### SUMMARY OF THE INVENTION

However, in the aforementioned conventional multi-plate braking system, in order to assemble the first brake plates and the second brake plates on a braking system body, the first brake plates and the second brake plates are initially installed on a brake hub. Subsequently, the brake hub, on which the plural of the brake plates have been assembled, is installed on an axle. However, at this time, the brake plates are prone to fall off the brake hub from either end in an axial direction of the brake hub. Therefore, it is necessary not to tilt the brake hub during assembly or, alternatively, it is necessary for the assembler to place hands on both ends of the brake hub at the time of assembly in order to prevent the brake plates from falling off the brake hub. Thus, such prior art multi-plate brake assemblies are not well-suited for mass production, and the assembly operation of the conventional braking system is difficult.

Preferred embodiments of the present invention address one or more of the foregoing problems. An object of one or more preferred embodiments is to provide a vehicle braking system that can improve the ability of the plurality of rotational friction plates and the plurality of fixed friction plates to be assembled on a system body.

In order to achieve the aforementioned object, a structural characteristic of a vehicle braking system of one or more preferred embodiments is that a sleeve section of a wheel hub that transmits rotational force of an axle to a wheel is coupled for rotation with an end of the axle. An annular member is coupled to a periphery of the sleeve section and is configured for rotation with the sleeve section and is removable by relative movement in the axle direction (along the axis of the sleeve section or in an axial direction). A plurality of annular rotational friction plates are engaged with the periphery of the annular member and are configured to allow relative movement between the rotational friction plates and the annular member in the axial direction and to prevent relative rotation between the rotational friction plates and the annular member (in the direction around the axle). A plurality of annular fixed friction plates includes a fixed friction plate disposed between each pair of the rotational friction plates. A periphery of each of the fixed friction plates is engaged with an inner periphery of a cylindrical engagement section of a brake housing. The brake housing is fixed to an axle support member, which supports the axle. The fixed friction plates capable of movement in the axial direction relative to the brake housing and are rotationally fixed to the brake housing. Rotation of the axle is restrained by pressing the plurality of rotational friction plates and the plurality of fixed friction plates against one another in the axial direction. Retaining members for preventing the rotational friction plates and the fixed friction plates from falling off the annular member are engaged with both ends of the annular member in the axial direction.

As described above, in an embodiment of the vehicle braking system, the retaining members are provided on both ends of the annular member in the axial direction in order to prevent the rotational friction plates assembled on the annular member and the fixed friction plates assembled on the rotational friction plates from falling off the annular member. Therefore, the ease of assembly of the annular member, on which the plural rotational friction plates and the plural fixed friction plates are assembled, onto the wheel hub is improved.

Other structural characteristic of the vehicle braking system according to an embodiment is that the fixed friction plates are provided with at least one projection, and preferably a plurality of projections, that projects from an outer periphery of the outer fixed friction plates. An outer fixed friction plate is disposed on the outside of each end of the collection of fixed and rotational friction plates in the axial direction. Each of the outer fixed friction plates is arranged within a cylindrical engagement section of the brake housing and configured for movement in the axial direction relative to the brake housing, but rotationally fixed with the brake housing. The outer friction plates are coupled with one another by one or more pins that extend through the projections. A retaining member for preventing the outer fixed friction plate from falling off are provided on each end of the pins in a state where both of the outer friction plates can be moved in the axial direction relative to the brake housing or annular member.

With such an arrangement, not only the plurality of fixed friction plates disposed between the plural rotational friction plates, but also the two outer fixed friction plates, which are disposed on the outside of the collection of friction plates in the axial direction, can be handled without becoming disengaged from the annular member. Therefore, it facilitates the operation of assembling the annular member to the wheel hub in a state where the plurality of rotational friction plates, the plurality of fixed friction plates, and the two outer fixed friction plates have been assembled on the annular member.

Further, other structural characteristic of the vehicle braking system according to an embodiment is that projections are respectively provided in generally equiangular positions in a direction of the circumference on both of the outer fixed friction plates, a pin is attached between the projections, and retaining members are provided on both ends of the pin. With such an arrangement, the outer fixed friction plates do not lean relative to one another, and thus, the outer fixed friction plates can be assembled in a state of greater stability.

Furthermore, other structural characteristic of the vehicle braking system according to an embodiment is that a spring member for urging both of the outer fixed friction plates to separate from one another is located between both of the outer fixed friction plates on the periphery of the pin. With such an arrangement, friction plates, such as both of the outer friction plates, separate from one another by spring members in an appropriate state when the vehicle braking system is not operated. Accordingly, the transmission of rotational force from the axle to the wheels is smooth. In addition, the pin is used as a member having two functions; one function is to couple both of the outer fixed friction plates with one another, and the other function is support a biasing member (e.g., spring) that tends to separate both of the outer fixed friction plates from one another. Therefore, the parts count and cost are reduced in this arrangement compared to the arrangement in which members for each function are separately provided. Also, a smooth dividing function of both of the outer fixed friction plates can be attained by mounting a plurality of the pins and providing the spring members to all the pins.

Moreover, another structural characteristic of the vehicle braking system according to an embodiment is that the sleeve section of the wheel hub and the annular member are splined to be removable, and that an inclined surface is provided in at least one of the sleeve section and the annular member for guiding the sleeve section and the annular member to align with one another when the sleeve section is brought into contact with the annular member. According to such an arrangement, when the annular member, on which the plurality of rotational friction plates and the like are assembled, is brought closer to the sleeve section for assembly, the center of the sleeve section and that of the annular member are urged to meet with one another. Therefore, the ease of assembly of the sleeve section of the wheel hub and the annular member for spline-fitting is improved and, thus, the assembly work is easier for the assembler.

Yet another structural characteristic of the vehicle braking system according to an embodiment is that at least one end portion of the axle support member is formed with a cylindrical shape. One end of the sleeve section of the wheel hub is disposed within the end portion of the axle support member with a gap between the sleeve section and the inner periphery of the end portion in the radial direction. A seal member is provided for making the gap between the axle support member and the sleeve section liquid-tight. With such an arrangement, the sealing structure between the axle support member and the sleeve section is simplified.

### BRIEF DESCRIPTION OF THE DRAWINGS

These and other features, aspects and advantages of the present vehicle braking system are described below with reference to preferred embodiments, which are intended to illustrate and not to limit the present invention. The drawings contain seventeen (17) figures.

FIG. 1 is a side view of a golf cart incorporating a vehicle braking system in accordance with an embodiment of the present invention.

FIG. 2 is a side view of a portion of the braking system inside the golf cart. Portions of the golf cart are illustrated in dashed lines for the purpose of clarity.

FIG. 3 is a plan view of the golf cart shown in FIG. 2, with the body and certain other components removed. An outline of each of the tires is illustrated in dashed lines.

FIG. 4 is a cross-section of the vehicle braking systems provided on each side of a rear axle as viewed from the front of the golf cart.

FIG. 5 is a sectional view of the vehicle braking system of FIG. 4 provided in a rear wheel connected to the left side of the rear axle.

FIG. 6 is a sectional view of the vehicle braking system.

FIG. 7 is a side view showing a coupling part of a brake wire and the vehicle braking system.

FIG. 8 is a sectional view taken along the line 8-8 of FIG. 6.

FIG. 9 is a sectional view taken along the line 9-9 of FIG. 6.

FIG. 10 is a sectional view taken along the line 10-10 of FIG. 6.

FIG. 11 is a sectional view taken along the line 11-11 of FIG. 6.

FIG. 12 is a sectional view taken along the line 12-12 of FIG. 6.

FIG. 13 is an elevational view showing a base surface section of a brake housing.

FIG. 14 is a sectional view taken along the line 14-14 of FIG. 13.

FIG. 15 is a sectional view in which a wheel hub is attached to the axle and is assembled onto an annular member.

FIG. 16 is a sectional view of aligning the wheel hub with the annular member.

FIG. 17 is a sectional view in which the wheel hub is spline-fitted to the annular member.

### DETAILED DESCRIPTION OF THE PREFERRED EMBODIMENTS

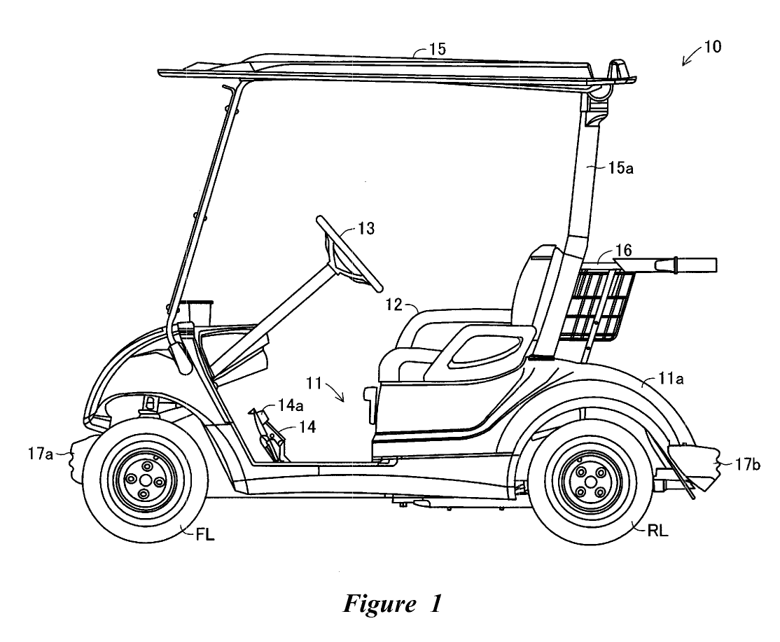

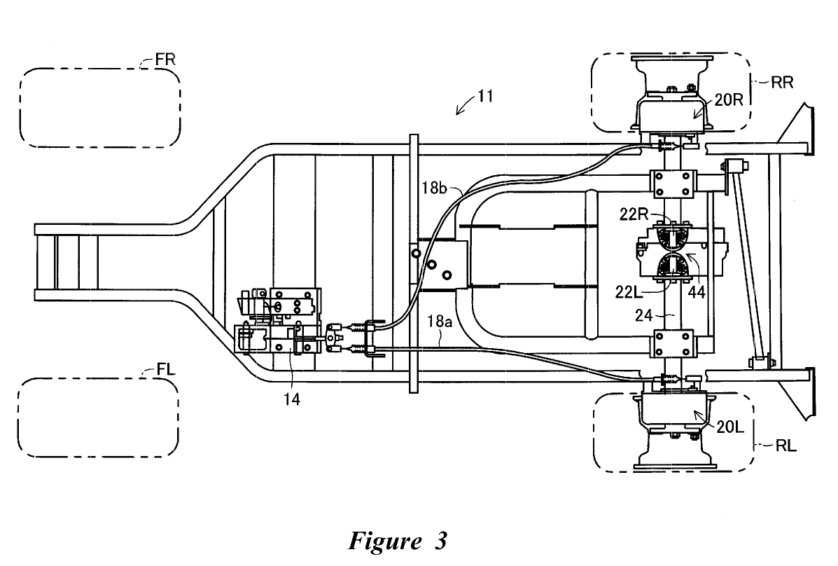

Description is hereinafter made of a vehicle braking system according to an embodiment of the present invention with reference to the drawings. FIG. 1 shows a wheeled vehicle, such as a golf cart 10, having a vehicle braking system according to the embodiment of the present invention. This golf cart 10 is provided with four wheels, which includes front wheels FL, FR provided on both left and right sides of a front section at the bottom of a vehicle body 11 (see FIG. 3) and rear wheels RL, RR provided on both left and right sides of the rear section at the bottom of the vehicle body 11 (see FIG. 3). A seat 12 is provided slightly toward a rear side of the center of the vehicle body 11 in a lengthwise direction. A steering wheel 13 is provided in front of the seat 12 and an accelerator pedal (not shown) and a brake pedal 14 are provided side by side below the steering wheel 13. In addition, a roof 15 is supported above the vehicle body 11 via a support frame 15a.

A baggage placement member 16 for placing golf club bags is attached over a cowl 11a, which configures a rear section of the vehicle body 11. A front bumper 17a is attached to a front bottom of the vehicle body 11, and a rear bumper 17b is attached to a rear bottom of the cowl 11a. The front wheels FL, FR change direction to the left or right when a driver sitting on the seat 12 turns the steering wheel 13. Consequently, the golf cart 10 changes a traveling direction by turning left or by turning right. Also, the golf cart 10 is accelerated in accordance with a position of the accelerator pedal when the driver presses the accelerator pedal.

In this case, the further the accelerator pedal is pressed, the more the golf cart 10 is accelerated. The less the accelerator pedal is pressed, the less the golf cart 10 is accelerated. If the position of the accelerator pedal is kept constant, the golf cart 10 travels at a constant rate. Meanwhile, when the driver presses the brake pedal 14, rotary drive of the rear wheels RL, RR is slowed or brought to a stop in accordance with an amount the brake pedal 14 pressed. In this case, braking force on the rear wheels RL, RR is proportional to the amount the brake pedal 14 is pressed. A parking pedal 14a is provided on one side in the horizontal direction at a top end of the brake pedal 14. If the parking pedal 14a is pressed while the brake pedal 14 being pressed, the brake pedal 14 is locked for retaining the braking system in an engaged position.

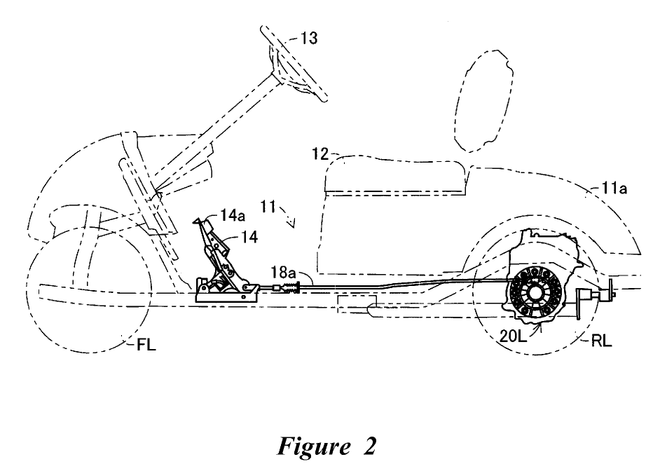

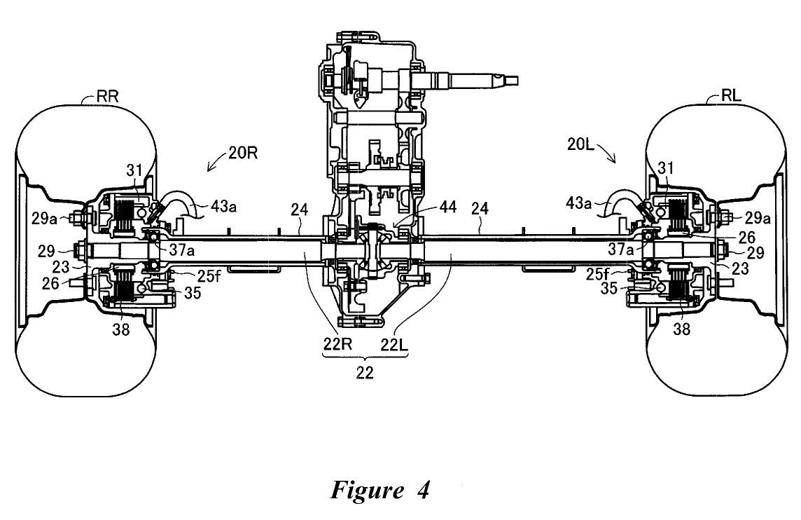

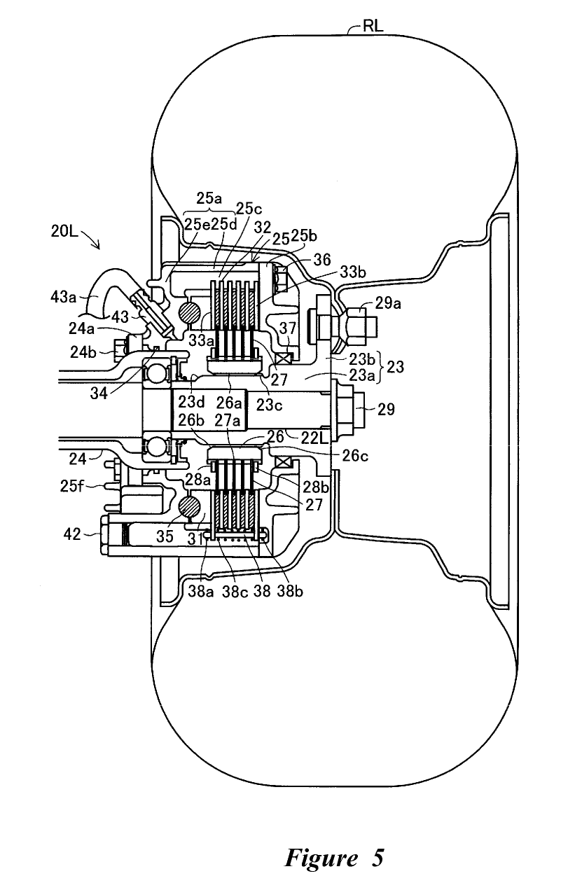

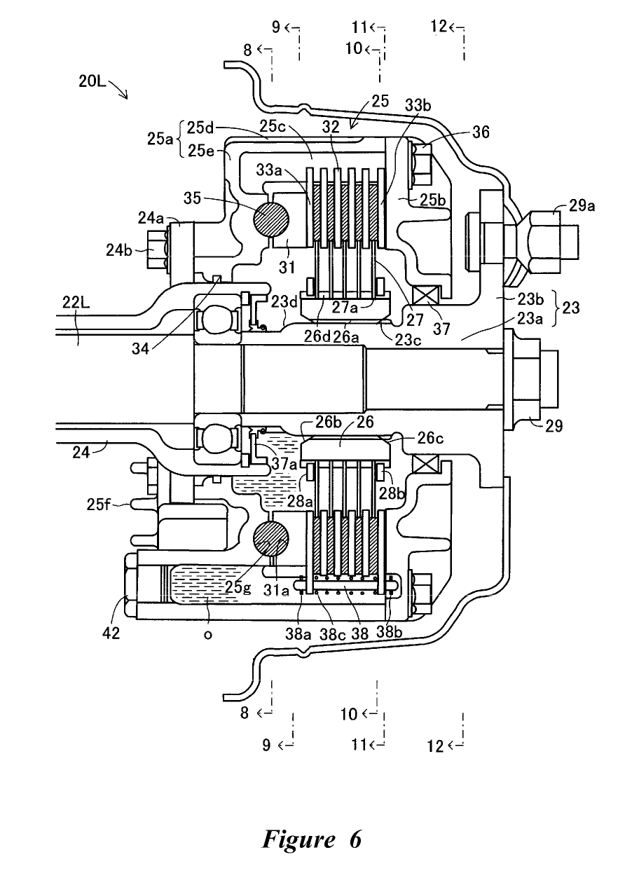

As shown in FIG. 2 and FIG. 3 (viewing the vehicle body 11 from above), the brake pedal 14 is coupled to vehicle braking systems 20L, 20R provided respectively on the rear wheels RL, RR via a pair of brake lines, or brake wires 18a, 18b. The vehicle braking systems 20L, 20R, as shown in FIG. 4 (viewing the vehicle body 11 from the front), are configured with generally same constructions disposed symmetrically. In addition, FIG. 5 shows the vehicle braking system 20L provided on the rear wheel RL, and FIG. 6 is an enlarged view of the vehicle braking system 20L in FIG. 5.

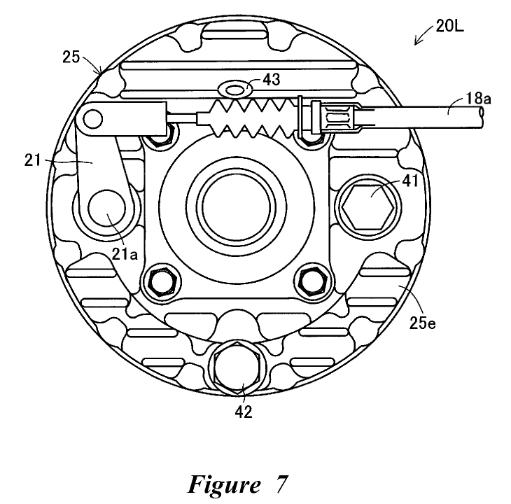

The vehicle braking system 20L is coupled with the brake wire 18a via a lever member 21 shown in FIG. 7, and a biasing member, such as a torsion spring (not shown), for urging the brake wire 18a rearward (to the left in the orientation shown in FIG. 7) acts on the lever member 21. An axle assembly 22 is formed with an axle 22L coupled with the rear wheel RL and an axle 22R coupled with the rear wheel RR. The vehicle braking system 20L includes a rotational portion formed with parts such as a wheel hub 23 attached to the left end of the axle 22L (left side viewing from the driver sitting on the seat 12, and right side in FIG. 4), and a fixed portion formed with parts such as a brake housing 25 attached via a tubular, preferably cylindrical, axle support member 24, which is provided on a periphery of the axle 22L.

The rotational portion of the vehicle braking system 20L includes an annular member 26, or a brake hub, coupled with the wheel hub 23, a plurality of rotational friction plates 27 attached onto a periphery of the annular member 26, and a pair of retaining members, or circlips 28a, 28b, which are attached to the opposite ends of the annular member 26. The wheel hub 23 is fixed to the periphery of the end of the axle 22L. The wheel hub 23 includes a cylindrical sleeve section 23a located closer to the center of the vehicle than the outermost end of the axle 22L and a flange section 23b, which is formed in a base of the sleeve section 23a (right end in FIG. 6). The wheel hub 23 is attached to be incapable of relative rotation with respect to the axle 22L in a direction around the axle, and rotates together with the axle 22L when the axle 22L rotates in the direction around the axle.

A periphery of the sleeve section 23 is formed with three steps, among which a diameter of a step in the base side (a portion that corresponds with the end of the axle 22L) is the largest, and the diameter of a step becomes smaller moving closer to the center of the axle 22L from the base side (i.e., toward the center of the vehicle 10). A plurality of spline teeth 23c, which extend in the axial direction of the sleeve section 23a, are formed at regular intervals around a circumference of a central portion of a periphery of the sleeve section 23a. An inclined surface 23d is formed along the circumference at a junction between the central portion and a relatively more inward portion with a smaller radius on the periphery of the sleeve section 23a such that the diameter of the inclined surface 23d gradually becomes larger as it gets close to the central portion from the portion with the smaller radius of the sleeve section 23a. A fastener, such as nut 29, is fixed to the end of the axle 22L and abuts a rim portion of an outward-facing surface of the fixed section 23b that surrounds a hole through which the axle 22L extends. Accordingly, the wheel hub 23 is prevented from falling off the axle 22L by the nut 29. The rear wheel RL is fixed to the fixed section 23b via a plurality of fasteners, such as a bolt and nut assembly 29a.

On an inner periphery of the annular member 26, a plurality of protrusions 26a are formed at regular intervals in a circumferential direction and extend in the axial direction. The protrusions 26a are sized and shaped to engage with the spline teeth 23c of the sleeve section 23a. The annular member 26 is spline-fitted to the sleeve section 23a by moving the annular member 26 in the axial direction along the periphery of the sleeve section 23a with the protrusions 26a aligned with the spaces between the spline teeth 23c. Inclined surfaces 26b, 26c or chamfers are formed along the circumference on both ends of the inner periphery of the annular member 26, and the diameters of both ends of the inner periphery of the annular member 26 are larger on the ends than in the center.

A plurality of spline teeth 26d are formed on the periphery of the annular member 26 at regular intervals around the circumference and extend in the axial direction. The plurality of rotational friction plates 27 are attached to the spline teeth 26d such that relative movement in the axial direction with respect to the annular member 26 is possible, but where relative rotation between the annular member 26 and the rotational friction plates 27 is prohibited. Projections, which are engageable with the spline teeth 26d, are formed in the inner periphery of each of the rotational friction plates 27. The rotational friction plates 27 are not rotatable relative to the annular member 26 due to the engagement of the projections 27a with the spline teeth 26d.

In addition, a groove around the circumference is formed adjacent to each end of the periphery of the annular member 26. Retaining members, such as retaining rings or circlips 28a, 28b, are respectively engaged with the grooves. In one embodiment, the circlips 28a, 28b are made of generally ring-shaped elastic members, wherein a portion of the circumference is interrupted to form an opening. The circlips 28a, 28b are attached to the grooves with a biasing force applied to the circlip 28a, 28b that tends to enlarge the opening. Once aligned with the grooves, the biasing force is released such that the circlips 28a, 28b return to their normal state and are engaged with the grooves. The plurality of rotational friction plates 27 are disposed between the circlips 28a and 28b, and are prevented from falling off or otherwise becoming disengaged with the annular member 26 by the circlips 28a, 28b.

The fixed portion of the vehicle braking system 20L includes the brake housing 25, a cam ring 31 disposed within the brake housing 25, a plurality of fixed friction plates 32, outer fixed friction plates 33a, 33b respectively disposed on each end of the collection of the entire plurality of fixed friction plates 32 and the rotational friction plates 27. The brake housing 25 includes a base (left-hand segment in FIG. 6) having an accommodation section 25a and a center portion, which includes an opening through which the axle support member 24 passes. A cover 25b blocks an opening at the open outer end of the accommodation section 25a. The plurality of fixed friction plates 32, 33a and 33b and the rotational friction plates 27 are accommodated within the brake housing 25.

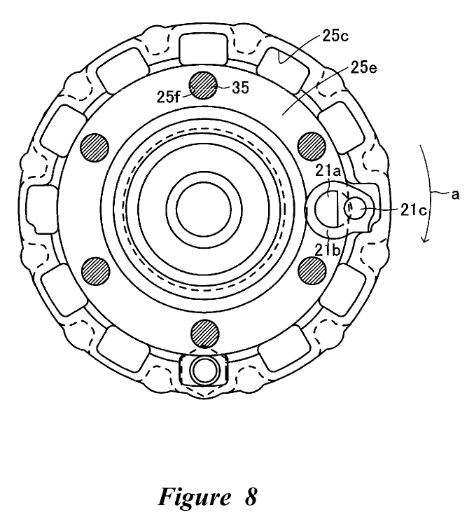

A plurality of engagement grooves 25c (see FIG. 6, FIG. 8 to FIG. 11), which extend in the axial direction, are formed on an inner periphery of an annular portion 25d at regular intervals around the circumference. The accommodation section 25a includes the annular portion 25d, as one embodiment of a cylindrical engagement part, and a base surface section 25e fixed to the axle support member 24 such that a rim portion of the base, which surrounds an opening through which the axle support member 24 passes, is closely coupled (preferably sealed) to a periphery of the axle support member 24 via an O-ring 34. In addition, the accommodation section 25a is coupled to the axle support member 24 by fixing a base opening edge of the base surface section 25e to a flange section 24a, which is fixed to the periphery of the axle support member 24 by welding, via a bolt 24b.

As shown in FIG. 8, six hemispherical depressions or holes 25f are formed in an inner surface of the base surface section 25e at regular intervals in a circumferential direction and a steel ball 35 is placed in each of the hemispherical holes 25f to be rotatable with its center as a rotational center. A rotational shaft 21a of the lever member 21 extends through the base surface section 25e into the inner surface of the base surface section 25e and a rotator 21b is fixed, such as by welding, on the distal periphery of the rotational shaft 21a. In addition, a pressing shaft 21c, which extends toward the inside of the accommodation section 25a, projects from a surface edge side of the rotator 21b. The rotator 21b is urged in a direction indicated by the arrow “a” in FIG. 8 by the aforementioned torsion spring. However, it rotates against the torsion spring in the opposite direction from the arrow “a” by the pressing operation of the brake pedal 14.

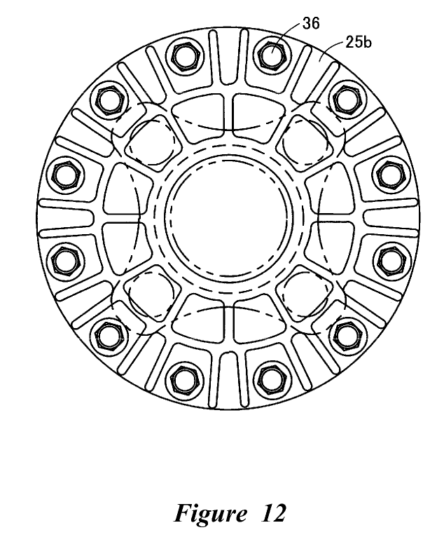

The cover 25b is, as shown in FIG. 12, formed with a plurality of recesses and ribs on the surface, is formed in a generally circular disk shape with an opening in its center, and is fixed to the accommodation section 25a by a plurality of fasteners, such as bolts 36, disposed at regular intervals around the circumference and toward an outer periphery. An oil seal 37 is provided between the rim of the opening of the cover 25b and the periphery of the portion of the sleeve section 23a with the larger radius (i.e., the outermost or right-most illustrated step portion in FIG. 6), and makes a space between the cover 25b and the sleeve section 23a liquid-tight. Meanwhile, the wheel hub 23 remains rotatable relative to the brake housing 25.

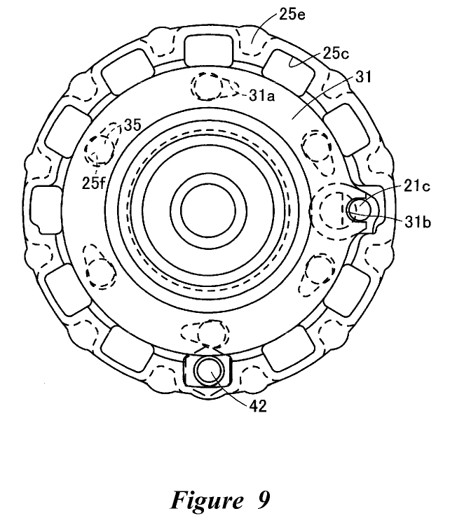

The cam ring 31 is provided within the brake housing 25 in a state where the cam ring 31 faces the inner surface of the base surface section 25e on which the hemispherical holes 25f are formed. Then, as shown in FIG. 9, pressing grooves 31 a are formed in portions of the cam ring 31, which respectively face each of the hemispherical holes 25f of the base surface section 25e. One end of each of the pressing grooves 31a is formed in a hemispherical shape and the other end narrows. The hemispherical portions of the pressing grooves 31a are formed generally symmetrical with the hemispherical holes 25f of the base surface section 25e and each of the steel balls 35 is accommodated between the hemispherical hole 25f and the hemispherical portion of the pressing groove 31a when the base surface section 25e and the cam ring 31 come close to one another.

Also, as the narrowed portions of the pressing grooves 31a become narrower, their depths get shallower. When each steel ball 35 is located between the hemispherical hole 25f and the narrowed portion of the pressing groove 31a, a gap between the base surface section 25e and the cam ring 31 widens. FIG. 6 shows the state where the gap between the base surface section 25e and the cam ring 31 becomes the narrowest. A portion in the cam ring 31 that corresponds with the pressing shaft 21c is formed with an engagement recess 31b in generally a hemispherical shape, and the pressing shaft 21c is engaged with the engagement recess 31b.

Therefore, when the brake wire 18a is pulled forward by the pressing operation of the brake pedal 14, the lever member 21 rotates. As a result, the rotational shaft 21a, the rotator 21b, and the pressing shaft 21c rotate along with the rotation of the lever member 21. In addition, because the cam ring 31 rotates by the rotation of the pressing shaft 21c, the cam ring 31 moves in a rotational direction relative to the base surface section 25e. Thereby, each steel ball 35 is respectively positioned in the narrowed portion side of the pressing grooves 31 a and the cam ring 31 separates from the base surface section 25e as it rotates.

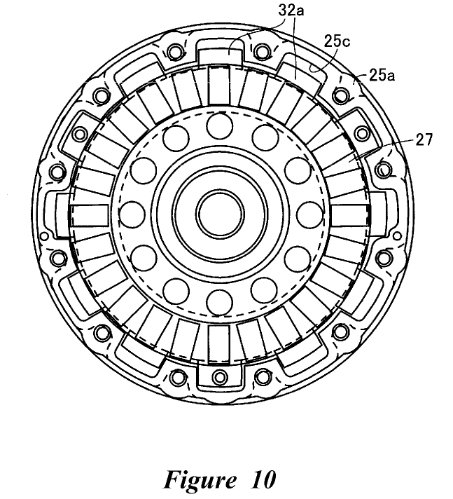

The intermediate fixed friction plates 32 includes a number of individual plates, each of which is disposed between adjacent pairs of the rotational friction plates 27, and includes a annular main body and plurality of engagement projections 32a (see FIG. 10) which project outward from a periphery of the main body. The engagement projections 32a are formed along the circumference of the annular main body at regular intervals so as to be engageable with the engagement grooves 25c of the accommodation section 25a. In addition, the outer fixed friction plates 33a, 33b are respectively disposed outside the two outermost rotational friction plates 27, which are positioned on each end of the plurality of rotational friction plates 27.

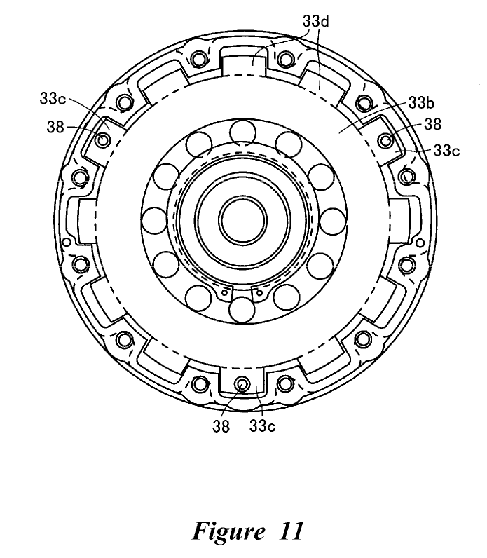

The outer fixed friction plates 33a, 33b are formed nearly in the same shape as the intermediate fixed friction plates 32; however, as shown in FIG. 11 (showing the outer fixed friction plates 33b), the projecting amount, or radial dimension, of three engagement projections 33c formed at regular intervals is larger than that of the other engagement projections 33d. Each of the engagement projections 33c is formed with a pin inserting hole, and pins 38 pass through the pin inserting holes. Grooves are respectively formed around the circumference on the periphery of each end of the pins 38.

By engaging circlips 38a, 38b as retaining tools with the grooves, both of the outer fixed friction plates 33a, 33b are prevented from falling off of, or otherwise becoming disengaged from, the pins 38. The engagement positions of both of the circlips 38a, 38b on the pins 38 are designed with some clearance so that a spacing between the outer fixed friction plates 33a and 33b can be varied along with the movement of the cam ring 31 in the axial direction. That is, the available space between the circlips 38a, 38b is configured to accommodate the fixed friction plates 32, 33a, 33b in a separated position and in a compressed position. Further, spring members 38c for separating the outer fixed friction plates 33a, 33b from one another are attached in portions between the outer fixed friction plates 33a and 33b on the peripheries of the pins 38.

Because the outer fixed friction plates 33a, 33b are separated from one another by the urging force of the spring members 38c when the brake operation is not performed, each of the rotational friction plates 27 and each of the fixed friction plates 32 can be separated from one another in an appropriate condition. Therefore, the rotational force of the axle 22L is transmitted to the rear wheel RL without receiving any (or only a negligible amount) resistance from the vehicle braking system 20L. On the other hand, when the brake operation is performed, the outer fixed friction plates 33a, 33b come close to one another against the urging force of the spring members 38c, and both of the outer fixed friction plates 33a, 33b, each of the rotational friction plates 27 and each of the fixed friction plates 32 are frictionally engaged to resist relative rotation therebetween. As a result, the rotation of the axle 22L can be slowed and, if desired, entered into a state where it cannot rotate.

An oil seal 37a is provided between the inner periphery at the outer end or tip of the axle support member 24 and the periphery of the small radius portion of the sleeve section 23a, and makes the area between the axle support member 24 and the sleeve section 23a liquid-tight. Meanwhile, the wheel hub 23 is maintained to be rotatable relative to the axle support member 24. A space between the wheel hub 23 and the axle support member 24, that between the axle support member 24 and the brake housing 25, and that between the brake housing 25 and the wheel hub 23 are respectively blocked by the oil seal 37a, the aforementioned O-ring 34 and the oil seal 37, and an enclosed space is formed in an area surrounded by the wheel hub 23, axle support member 24 and the brake housing 25.

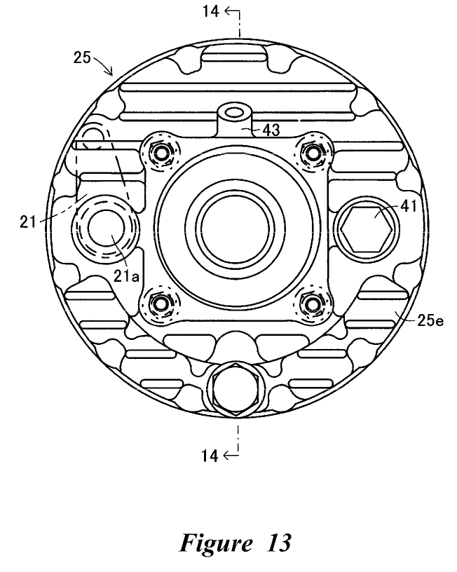

Preferably, lubrication oil O is provided in the enclosed space. The oil level of the oil O is, as shown in FIG. 6, preferably is slightly lower than the lower end portion of the small radius portion (i.e., portion on which the seal 37a is engaged) of the sleeve section 23a when the axle 22L is not rotating. Once the axle 22L starts rotating, the oil O is stirred and spattered within the enclosed space. In addition, a screw hole, into which a bolt 41 (FIG. 13) attached in the central front side of the base surface section 25e of the brake housing 25 is screwed, is connected to the enclosed space formed by the brake housing 25, etc. Therefore, the oil O can be poured into the enclosed space from the screw hole by removing the bolt 41.

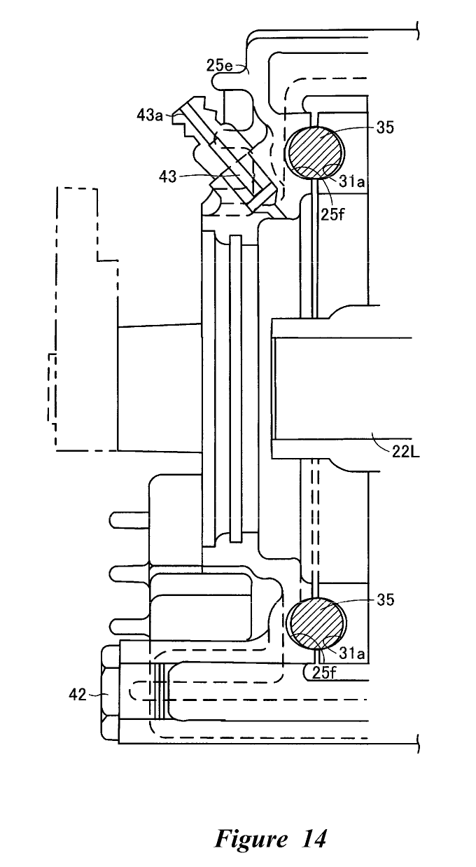

A screw hole, into which a bolt 42 attached to the bottom of the base surface section 25e of the brake housing 25 is screwed, is also connected to the enclosed space formed by the brake housing 25, etc. Therefore, when the oil O in the enclosed space deteriorates, the oil 0 can be discharged to the outside of the enclosed space from the screw hole by removing the bolt 42. In addition, as shown in FIG. 13 and FIG. 14, a cylindrical air inlet 43, which extends obliquely upward, is formed on the upper side portion of the base surface section 25e, and one end of a hose 43a is attached to the air inlet 43. The enclosed space is maintained in the atmospheric pressure by communicating the enclosed space with the outside via the air inlet 43 and the hose 43a. Meanwhile, the other end of the hose 43a is positioned in an appropriate location on the vehicle 11 so that water, dust and the like do not enter the air inlet 43 via the hose 43a.

The vehicle braking system 20R is provided at a right end of the axle 22R, and is substantially similar to the vehicle braking system 20L. That is, each component constituting the vehicle braking system 20R is the same as that constituting the vehicle braking system 20L, and only the screw holes and the like provided in the brake housing 25 and the like are respectively provided in appropriate positions. Therefore, a description of the vehicle braking system 20R is not repeated by assigning the same reference numeral of each component constituting the vehicle braking system 20L to that constituting the vehicle braking system 20R in FIG. 4.

Also, as described above, the axle 22 includes the axle 22L coupled with the rear wheel RL side and the axle 22R coupled with the rear wheel RR side, and the central ends of the axle 22L and the axle 22R are coupled via a differential gear 44 (FIGS. 3 and 4). The differential gear 44 is coupled with an engine (not shown) via each coupling mechanism, and separately transmits drive force of the engine to the axle 22L and the axle 22R. Thereby, the golf cart 10 can turn smoothly even if a gap occurs between the length of the trajectory of the rear wheel RL and that of the rear wheel RR when the golf cart 10 makes a turn.

A method for assembling the vehicle braking systems 20L, 20R, including a structure substantially as described above, on the axle 22 of the golf cart 10 is described below. In this case, initially, one of the circlips 28a, 28b, for example the circlip 28a, is attached to one end of the annular member 26. Then, the rotational friction plates 27 and the fixed friction plates 32 are alternately assembled to the periphery of the annular member 26. At this time, each of the projections 27a formed on the inner peripheries of the rotational friction plates 27 are mated with the spline teeth 26d of the annular member 26, and the friction plates 27 are moved from one end of the annular member 26 to the other. Also, the fixed friction plates 32 are assembled between adjacent pairs of the rotational friction plates 27 and are disposed so that the centers of the fixed friction plates 32 are aligned with those of the rotational friction plates 27.

When the assembly of the rotational friction plates 27 and the fixed friction plates 32 on the annular member 26 is completed, the circlip 28b is attached to the other end of the annular member 26. Thereby, the rotational friction plates 27 and the fixed friction plates 32 are prevented from falling off of, or otherwise becoming disengaged with, the annular member 26. Subsequently, the outer fixed friction plate 33a is disposed on the outside of one of the two rotational friction plates 27 positioned at the ends of the annular member 26 while the outer of the two fixed friction plate 33b is disposed on the outside of the other rotational friction plate 27. The pins 38 are inserted through the pin inserting holes of both of the outer fixed friction plates 33a, 33b. The rotational friction plates 27, the fixed friction plates 32, and the outer fixed friction plates 33a, 33b are securely assembled onto the annular member 26 by respectively attaching the circlips 38a, 38b to the grooves in both ends of the pins 38 to form a subassembly of the annular member 26 and collection of friction plates 27, 32, 33a and 33b.

Next, the cam ring 31 is positioned adjacent to the inner surface of the base surface section 25e with the steel balls 35 therebetween such that approximately half of the steel ball 35 is placed within each hemispherical hole 25f of the base surface section 25e, and the other approximately half of the steel ball 35 is placed in each pressing groove 31a of the cam ring 31. Then, after inserting the axle 22L into the central hole of the annular member 26, on which the rotational friction plates 27 and the like have been assembled, the annular member 26 and the like are moved to the cam ring 31 side, and then the outer fixed friction plate 33a is pressed against the cam ring 31. At this time, the engagement projections 32a of the fixed friction plate 32 and the engagement projections 33c, 33d of the respective outer fixed friction plates 33a, 33b are respectively engaged with the engagement grooves 25c formed on the annular portion 25d of the accommodation section 25a.

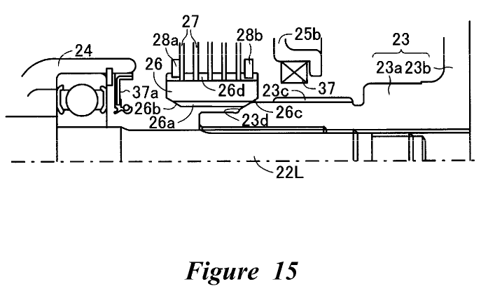

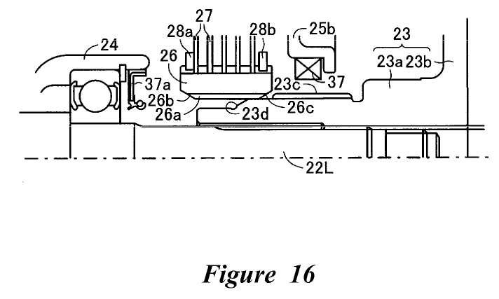

The cover 25b is placed outside the rim of the opening of the accommodation section 25a and is fixed to the accommodation section 25a by the bolts 36. Thereby, the annular member 26, on which the rotational friction plates 27 and the like have been assembled, is accommodated in the brake housing 25. Then, the accommodation section 25a of the brake housing 25 is fixed to the flange section 24a by the bolt 24b (FIGS. 5 and 6). Next, as shown in FIG. 15, the axle 22 is inserted into the central hole of the wheel hub 23, and the wheel hub 23 is moved toward the center end of the axle 22L (i.e., the end near the centerline of the vehicle 10 in a lateral direction). When the inclined surface 23d of the wheel hub 23 comes into contact with the inclined surface 26c of the annular member 26, the position of the central axis of the annular member 26 is adjusted to meet with the central axis of the sleeve section 23a. Then, as shown in FIG. 16, the center portion of the sleeve section 23a enters the inner periphery side of the annular member 26.

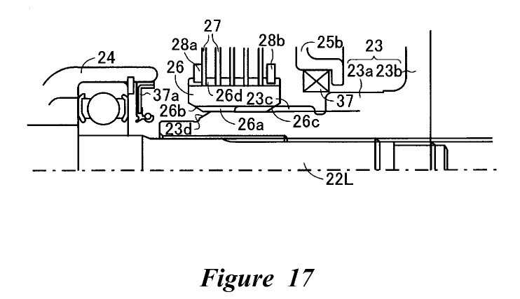

As the wheel hub 23 is further moved toward the center side of the axle 22L, as shown in FIG. 17, the spline teeth 23c of the sleeve section 23a come to fit with the protrusions 26a of the annular member 26, and the center portion of the sleeve section 23a is further inserted into the inner periphery side of the annular member 26. Once the tip of the sleeve section 23a reaches the interior of the axle support member 24, the space between the axle support member 24 and the portion of the periphery of the small radius portion of the sleeve section 23a is enclosed by the oil seal 37a, and the space between the cover 25b and the portion of the periphery of the large radius portion of the sleeve section 23a is also enclosed by the oil seal 37.

In such a state, the wheel hub 23 is fixed to the axle 22L by attaching the nut 29 to the end of the axle 22L. Thereby, the assembly of the vehicle braking system 20L on the axle 22L is completed. Meanwhile, the assembly of the vehicle braking system 20R on the axle 22R is conducted in an assembly process, which is similar to the aforementioned assembly process. Moreover, the rear wheel RL is attached to the wheel hub 23 of the vehicle braking system 20L via the nut(s) 29a, and the rear wheel RR is attached to the wheel hub 23 of the vehicle braking system 20R via the nut(s) 29a.

Advantageously, in the vehicle braking system 20L, 20R according to this embodiment, the circlips 28a, 28b are provided on both ends of the annular member 26 so that the plurality of rotational friction plates 27 and the plurality of fixed friction plates 32, both of which are assembled on the annular member 26, are prevented from falling off the annular member 26 by the circlips 28a, 28b. In addition, the outer fixed friction plates 33a, 33b are respectively arranged outside of the two outer rotational friction plates 27. Both of the outer fixed friction plates 33a, 33b are coupled to one another by insertion of the three pins 38, and the circlips 38a, 38b are attached to both ends of the pins 38 for preventing the outer fixed friction plates 33a, 33b from becoming dislodged from the pins 38.

Such an arrangement facilitates the operation of assembling the annular member 26, on which the plurality of rotational friction plates 27, the plurality of fixed friction plates 32 and the outer fixed plates 33a, 33b are assembled, onto the brake housing 25 and the wheel hub 23. In addition, because the three pins 38 for coupling the outer fixed friction plates 33a, 33b with one another are disposed along the circumferences of the outer fixed friction plates 33a, 33b at regular intervals, the outer fixed friction plates 33a, 33b can be assembled in a state of greater stability.

Further, the spring member 38c for urging the outer fixed friction plates 33a, 33b to separate from one another is provided in the portion between the outer fixed friction plates 33a and 33b on the periphery of each of the pins 38. Because the outer fixed friction plates 33a and 33b are separated from one another by the urging force of the spring members 38c when the brake operation is not performed, each of the rotational friction plates 27 and each of the fixed friction plates 32 are also separated from one another in an appropriate state. Therefore, the rotational force of the axle 22 is transmitted to the rear wheels RL, RR without receiving any (or any significant) resistance from the vehicle braking systems 20L, 20R.

On the other hand, when the brake operation is performed, each of the fixed friction plates 32 and both of the outer fixed friction plates 33a, 33b move along the engagement grooves 25c formed in the annular portion 25d of the accommodation section 25a, and each of the rotational friction plates 27 moves along the spline teeth 26d of the annular member 26. In addition, the annular member 26 can move along the spline teeth 23c of the sleeve section 23a. Thereby, each of the rotational friction plates 27, and each of the fixed friction plates 32 and the like can be pressed smoothly, and thus, smooth braking becomes possible. In addition, the pin 38 is used as a member having two functions: one function is to couple the outer fixed friction plates 33a, 33b with one another; and the other is to separate the outer fixed friction plates 33a, 33b from one another (in cooperation with the spring 38c). Therefore, the parts count and cost are reduced in this case compared to the case where members with each function are separately provided.

Further, the inclined surface 23d is formed on the sleeve section 23a of the wheel hub 23, and also the inclined part 26c is formed on the inner periphery of the annular member 26. Thereby, when the sleeve section 23a and the annular member 26 are assembled, the position of the central axis of the annular member 26 is adjusted to align with the central axis of the sleeve section 23a. Consequently, the assembly operation of the sleeve section 23a to the annular member 26 is improved. In addition, the end portion of the axle support member 24 is formed in a cylindrical shape and the oil seal 37a is provided between the inner periphery of the end of the axle support member 24 and the small radius portion of the sleeve section 23a. Therefore, the sealing structure between the axle support member 24 and the sleeve section 23a is simplified. Furthermore, because the vehicle braking system 20L and the vehicle braking system 20R are formed symmetrically, and also because components constituting those are shared, the cost reduction and simplification of manufacture can be promoted.

The present invention is not limited to the embodiment described above and is able to be implemented with various modifications. For example, circlips 38a, 38b are used as retaining members in each embodiment described above; however, instead of circlips 38a, 38b, other suitable retaining members, such as a collar, for example, may be provided on one end of a pin 38 and a retaining part, such as a pin, clip and the like, may be provided on the other end. Also, as a retaining member, a ring-shaped engagement member may be used instead of circlips 28a, 28b. Further, in the aforementioned embodiment, a golf cart 10 is used as a vehicle; however, a vehicle in the present invention is not limited to the golf cart 10, but any vehicle can be used as far as it includes a multi-disc braking system, or other energy transfer system. Furthermore, the configuration of the components of the vehicle braking system other than those described herein can be accordingly changed within the technical scope of the present invention. In addition, although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Additionally, it is contemplated that various aspects and features of the invention described can be practiced separately, combined together, or substituted for one another, and that a variety of combination and subcombinations of the features and aspects can be made and still fall within the scope of the invention. Thus, it is intended that the scope of the present invention herein disclosed should not be limited by the particular disclosed embodiments described above, but should be determined only by a fair reading of the claims.

What is claimed is:

1. A vehicle braking system, comprising:
an axle;
an axle support that rotatably supports the axle;
a wheel hub for transmitting a rotational force of the axle to a wheel, the wheel hub including a sleeve section that is rotatably coupled to a one end of the axle;
an annular member that is capable of being assembled to a periphery of the sleeve section, wherein the annular member is removable from the sleeve section by relative movement in an axial direction and, when assembled, is fixed for rotation with the sleeve section;
a plurality of annular rotational friction plates that are engaged with the periphery of the annular member, wherein the plurality of rotational friction plates and are movable relative to the annular member in the axial direction and coupled for rotation with the annular member;
a plurality of annular fixed friction plates, wherein each one of the plurality of fixed friction plates is positioned between a pair of the plurality of rotational friction plates;
a brake housing fixed to the axle support member, wherein a periphery of each of the plurality of fixed friction plates is engaged with an inner periphery of a cylindrical engagement section of the brake housing such that the plurality of fixed friction plates are coupled for rotation with the brake housing but are capable of axial movement relative to the brake housing, wherein rotation of the axle is restrained by pressing the plurality of rotational friction plates and the plurality of fixed friction plates against one another in the axial direction;
a first retaining member and a second retaining member, wherein the first and second retaining members are engaged with first and second ends of the annular member, respectively, and block the plurality of rotational friction plates and the plurality of fixed friction plates from becoming disengaged with the annular member in the axial direction.

2. The vehicle braking system of claim 1, further comprising a first outer fixed friction plate and a second outer fixed friction plate, wherein each of the first and second outer fixed friction plates are provided with at least one projection that projects in a radially outward direction, and wherein the first outer fixed friction plate is positioned adjacent a first end of the plurality of rotational friction plates and the second outer fixed friction plate is positioned adjacent a second end of the plurality of rotational friction plates, each of the first and second outer fixed friction plates are rotatably coupled with the cylindrical engagement section of the brake housing and are capable of axial movement relative to the cylindrical engagement section, wherein the first and second outer friction plates are coupled with one another by at least one pin that extends through respective openings in the at least one projection and first and second pin retaining members are engaged with first and second ends of the pin for preventing the first and second outer fixed friction plates from becoming disengaged from the pin by axial movement, wherein a spacing between the first and second pin retaining members is sufficient to allow the first and second outer fixed friction plates, the plurality of fixed friction plates and the plurality of rotational friction plates to move between a compressed orientation and a separated orientation.

3. The vehicle braking system of claim 2, wherein the at least one projection comprises a plurality of projections spaced from one another at generally equiangular positions around the circumference of the first and second outer fixed friction plates and the at least one pin comprises a plurality of pins, one of which is provided for each of said plurality of projections.

4. The vehicle braking system of claim 3, further comprising a plurality of spring members for urging the first and second outer fixed friction plates apart from one another, wherein one of the plurality of spring members is supported by the each one of the plurality of pins and is positioned between the first and second outer fixed friction plates.

5. The vehicle braking system of claim 2, further comprising at least one spring member for urging the first and second outer fixed friction plates apart from one another, wherein the at least one spring member is supported by the at least one pin and is positioned between the first and second outer fixed friction plates.

6. The vehicle braking system of claim 1, wherein the sleeve section of the wheel hub and the annular member are coupled by a splined connection, and an inclined surface is provided on at least one of the sleeve section and the annular member for guiding the sleeve section and the annular member into axial alignment with one another when the annular member is assembled to the sleeve section.

7. The vehicle braking system of claim 1, wherein a first end portion of the axle support member is generally tubular, a first end of the sleeve section of the wheel hub is disposed within the first end portion of the axle support member with a radial gap defined between a inner periphery of the first end portion of the axle support member and the first end of the sleeve section, and further comprising a seal member that seals the radial gap between the axle support member and the sleeve section in a substantially liquid-tight manner.

8. A vehicle braking system, comprising:
an axle;
a wheel hub for transmitting a rotational force of the axle to a wheel, the wheel hub including a sleeve section that is rotatably coupled to a one end of the axle;
an axle support that rotatably supports the axle;
a brake housing fixed to the axle support member;
a sub-assembly for selectively frictionally engaging the wheel hub and the brake housing, comprising:
a brake hub that is capable of being assembled to a periphery of the sleeve section of the wheel hub by relative movement in an axial direction and, when assembled, is fixed for rotation with the sleeve section;
a plurality of first friction plates that are rotationally fixed to the brake hub and are movable relative to the brake hub in the axial direction;
a plurality of second friction plates, wherein each one of the plurality of second friction plates is positioned between a pair of the plurality of first friction plates, wherein the plurality of second friction plates are rotationally fixed to the brake housing and are capable of axial movement relative to the brake housing, wherein rotation of the axle is restrained when the plurality of first friction plates and the plurality of second friction plates are compressed in the axial direction into frictional engagement with one another;
a first retaining member and a second retaining member, wherein the first and second retaining members are engaged with first and second ends of the annular member, respectively, and block the plurality of first friction plates and the plurality of second friction plates from becoming disengaged with the annular member in the axial direction.

9. The vehicle braking system of claim 8, further comprising a first outer friction plate and a second outer friction plate, which are positioned on opposite ends of the plurality of first friction plates and the plurality of second friction plates assembled on the brake hub, wherein the first and second outer friction plates are rotationally fixed to the brake housing and are capable of axial movement relative to the brake housing, and further comprising at least one pin passing through respective openings in both the first and second outer friction plates, wherein a first pin retaining member and a second pin retaining member are coupled to at least one pin on opposing sides of the first outer friction plate and the second outer friction plate at locations spaced a sufficient distance to accommodate the first and second outer friction plates with the collection of first and second outer friction plates, the plurality of first friction plates and the plurality of second friction plates are in the separated position.

10. The vehicle braking system of claim 9, further comprising at least one biasing member configured to normally bias the first outer friction plate and the second outer friction plate apart from one another.

11. The vehicle braking system of claim 10, wherein the at least one biasing member is a spring supported by the at least one pin.

12. The vehicle braking system of claim 9, wherein the openings through which the at least one pin passes is formed in a radial projection of each of the first outer friction plate and the second outer friction plate.

13. The vehicle braking system of claim 8, wherein the sleeve section of the wheel hub and the brake hub are coupled by a splined connection, and an inclined surface is provided on at least one of the sleeve section and the brake hub for guiding the sleeve section and the brake hub into axial alignment with one another when the brake hub is assembled to the sleeve section.

14. The vehicle braking system of claim 8, wherein a first end portion of the axle support member is generally tubular, a first end of the sleeve section of the wheel hub is disposed within the first end portion of the axle support member with a radial gap defined between a inner periphery of the first end portion of the axle support member and the first end of the sleeve section, and further comprising a seal member that seals the radial gap between the axle support member and the sleeve section in a substantially liquid-tight manner
